(19) United States
(12) Patent Application Publication
(10) Pub. No.: US 2025/0033495 A1
(43) Pub. Date: Jan. 30, 2025

(54) AUTO EJECTING FAST CHARGING CONNECTOR SYSTEMS, METHODS, AND DEVICES

(71) Applicant: Skyline Mobility Inc., Torrance, CA (US)

(72) Inventor: Edward Putman Reams, Torrance, CA (US)

(73) Assignee: Skyline Mobility Inc., Torrance, CA (US)

(21) Appl. No.: 18/780,818

(22) Filed: Jul. 23, 2024

Related U.S. Application Data
(60) Provisional application No. 63/528,888, filed on Jul. 25, 2023.

(51) Int. Cl. B60L 53/16; B60L 53/18; B60L 53/62

(52) U.S. Cl. CPC B60L 53/16; B60L 53/18; B60L 53/62; B60L 2200/12

(57) ABSTRACT

A charging connector for an electric vehicle is disclosed. The system comprises a power supply electrically connected to the charging connector by a cable. The charging connector is configured to charge the electric vehicle. The charging connector is further configured to eject from the electric vehicle when the electric vehicle reaches a suitable threshold.

### CROSS-REFERENCE TO RELATED APPLICATION

This application claims priority to, and the benefit of, U.S. Provisional Patent Application No. 63/528,888, filed Jul. 25, 2023, and entitled “Auto Ejecting Fast Charging Connector Systems, Methods, and Devices,” which is hereby incorporated by reference herein.

### FIELD OF INVENTION

The present disclosure relates generally to charging connectors for Electric Vehicles (“EV” or “eV”), such as EV scooters, EV motor bikes, and other EV vehicles, particularly to an ejecting charging connector system for EV charging.

### BACKGROUND

It is desirable to increase the speed and efficiency of charging stations for fast charging of EVs such as electric two wheelers (“e2Ws”), eScooters, electric bikes, eMotorcycles, eMopeds, trikes and the like. When charging stations become busy there is a need for quicker turnover between EVs. When charging EV's the EV Battery Management System (“BMS”) may slow down charging as the EV battery reaches a higher state of charge. This reduction in charge rate protects the battery from damage and increases the safety of charging the EV. As a result, the efficiency of a charging station falls off dramatically when users are charging the last 10 to 20 percent of the battery. If the charging station is charging by the kW, the profitability is reduced when the charge rate goes down. Many charging stations allow users to fully charge EVs, which can take extensive amounts of time. Further, when EVs are charged the charge rate may be reduced as the EV battery state of charge (“SOC”) increases. Thus, there is a need to fast charge EVs to a suitable SOC and allow a greater number of users to access the fast chargers.

### BRIEF DESCRIPTION OF THE DRAWING FIGURES

Additional aspects of the present disclosure will become evident upon reviewing the non-limiting embodiments described in the specification and the claims taken in conjunction with the accompanying figures, wherein like numerals designate like elements, and:

FIG. 1 illustrates a charging station comprising an auto ejecting charging connector, in accordance with various example embodiments;

FIG. 2 illustrates an auto ejecting charging connector system in accordance with various example embodiments:

FIG. 3 illustrates a method of auto ejecting a charging connector for an electric vehicle, in accordance with various example embodiments:

FIG. 4 illustrates a perspective view of a charging connector, in accordance with various embodiments; and

FIGS. 5A and 5B illustrate a release mechanism for an auto ejecting charging connector, in accordance with various embodiments.

### DETAILED DESCRIPTION

Reference will now be made to the exemplary embodiments illustrated in the drawings, and specific language will be used herein to describe the same. It will nevertheless be understood that no limitation of the scope of the disclosure is thereby intended. Alterations and further modifications of the inventive features illustrated herein, and additional applications of the principles of the disclosure as illustrated herein, which would occur to one skilled in the relevant art and having possession of this disclosure, are to be considered within the scope of the disclosure.

In various embodiments, automatic ejecting charging connectors are disclosed. In accordance with an example embodiment, an EV charging station may comprise an automatic ejecting charging connector configured for the charging connector to automatically eject as determined by the charging station. This is in contrast to typical EV charging stations where the amount of charging is controlled by the user, and where the unlocking/disconnecting of the charging cable is controlled by the user. In one example embodiment, the EV charger is configured to: stop charging the battery, unlock the charging cable, and/or eject the charging cable (sometimes individually or collectively termed “auto eject”). In an example embodiment, the EV charging station is configured to auto eject as controlled by the charging station controller. In an example embodiment, the charging station controller may send a signal to cause the cable to auto eject.

In various embodiments, the automatic ejecting charging connectors may be configured to charge various eVs, for example electric scooters (eScooter), electric bikes (eBike), electric mopeds (eMoped), electric motorcycles (eMotorcycle), electric trikes (eTrike), electric all-terrain-vehicles (eATV), side-by-sides, utility terrain vehicles, multipurpose off-highway utility vehicles, golf carts, boats, one-wheels, hoverboards and/or the like. In various example embodiments, the EV is a one-wheel, two-wheel three-wheel EV. In various embodiments, the eVs may further include larger vehicles such as four-wheel electric cars, electric passenger vehicles, electric trucks and sedans, etc.

In accordance with an example embodiment, the charging station controller may be configured to determine when it would be advantageous to stop charging a present EV in favor of charging the next EV. For example, the charging station controller may cause an auto eject when the EV is charged to a suitable amount, also referred to as a threshold state of charge (“SOC”). When the EV is initially charging, the charging connector may only be removed by the vehicle operator. This may provide the benefit of both safety, and ensuring the correct user is charging their EV to a desired amount. When the EV is charged to a suitable amount, the auto ejecting charging connector may either stop charging, unlock the charging connector, and/or disconnect or eject the charging connector. When the charging connector auto ejects following the EV having charged to a suitable amount, a second user may then use the EV charging station with charging connector. This provides the benefit of allowing the second user to charge their EV more quickly and efficiently.

In various embodiments, the auto ejecting charging connector may comprise an ejecting mechanism. The auto ejecting charging connector may connect to the Battery Management System (“BMS”) and/or Vehicle Control Module (“VCU”). The charging station or charging station control system may receive the SOC of the battery of the EV via the auto ejecting charging connector. The charging station control system may determine if the user has had enough time to charge the EV or if the EV has reached a suitable charge. The charging station control system may determine if a suitable SOC has been met and enable the auto ejecting charging connector.

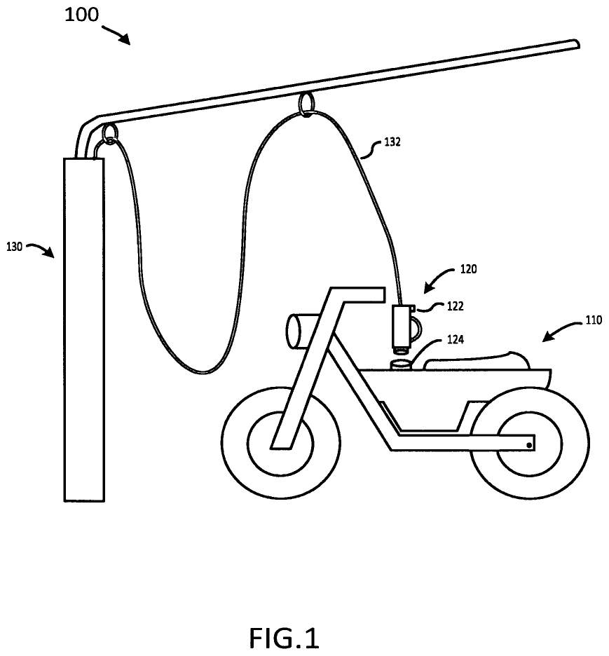

In accordance with an example embodiment, and with reference to FIG. 1, a charging station 100 comprising an auto ejecting charging connector 120 is shown. The charging station 100 may comprise a charger bay 130. The charger bay 130 may be electrically connected to the auto ejecting charging connector 120 by a cable 132.

In various embodiments, the auto ejecting charging connector 120 may be configured to connect to an electric vehicle 110. In various embodiments, the auto ejecting charging connector 120 may connect to a charge port 124. The auto ejecting charging connector 120 may be configured to attach and charge an electric vehicle 110. In various embodiments, the auto ejecting charging connector 120 may receive the SOC from the BMS or VCU of the electric vehicle 110. In various embodiments, the auto ejecting charging connector 120 may lock in place as the electric vehicle 110 is charging. For example, the auto ejecting charging connector 120 may lock to the charge port 124. This locking function may prevent a stranger from stopping the charging prematurely. In various embodiments, the auto ejecting charging connector 120 may “eject” or disconnect in response to the receiving the SOC from the electric vehicle 110. For example, when the electric vehicle 110 charges to a suitable threshold, such as 75% SOC, the auto ejecting charging connector 120 may eject. Moreover, the system may be configured to eject the auto ejecting charging connector 120 at any predetermined threshold SOC. In another example embodiment, the threshold SOC may be varied according to other variables. For example, if the charging station 100 is not very busy, if there are empty charging stalls, or the like, the charging station can be configured to raise the threshold ejection SOC to 100%. But if there is a line of cars waiting for a charge, if the time of day is one that is historically busy, if all the charging stalls are full, and the like, the threshold ejection SOC could be lowered to 90%, 80%, 75% or the like.

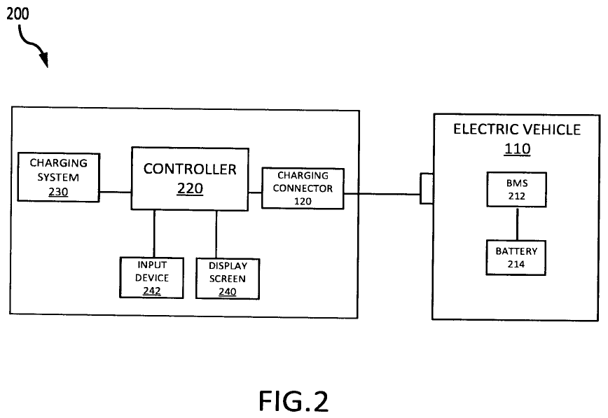

In various embodiments, the charger bay 130 may comprise additional components, such as a controller or charging system. The charger bay 130 may comprise a power supply suitable for charging an EV, such as a direct current fast charger (“DCFC”) or other suitable charging system. The charger bay 130 may further comprise user inputs and/or a display screen, as shown in reference to FIG. 2.

In various embodiments, cable 132 may be a retractable cable. In various embodiments, cable 132 may allow the auto ejecting charging connector 120 to be suspended overhead to more easily connect to an EV. Further, the cable 132 may retract or recoil once the auto ejecting charging connector 120 is ejected. In various embodiments, the cable 132 may retract or recoil upwards or into the charger bay 130.

In various embodiments, the auto ejecting charging connector 120 may further comprise an indicator light 122. In various embodiments, the indicator light 122 may display a color or light when the charging is complete or the electric vehicle 110 has reached a suitable charge. For example, the indicator light 122 may emit light or show green when the electric vehicle 110 is charged to 75%. In various embodiments, indicator light 122 may emit light or show green when the auto ejecting charging connector 120 is available for use. In this regard, a potential customer next in line may be alerted that charging of a present EV has stopped and they may transfer the charging connector 120 from the present EV to their ‘next’ EV. Moreover, any suitable system may be used to alert the next customer in line that they may transfer the charging connector 120 from the present EV to their ‘next’ EV, such as for example: text messages, in application messaging, audible alerts, and/or the like.

With reference now to FIG. 2, in accordance with an example embodiment, an auto ejecting charging connector system 200 is shown. The auto ejecting charging connector system 200 may comprise a controller 220. In various embodiments, the controller 220 may be connected to the charging system 230 and to the auto ejecting charging connector 120. The charging connector 120 may be configured to be removably connected to the electric vehicle 110, as shown in FIG. 2. Further, as shown in FIG. 2 and described in reference to FIG. 1, the charging connector 120 may be connected to the BMS 212 and battery 214. The charging connector 120 may provide power to the battery 214 of the electric vehicle 110 to charge the battery 214. Further, in various embodiments, the charging connector 120 may receive information from the BMS 212 of the electric vehicle 110.

In various embodiments, the controller 220 may receive the SOC from the electric vehicle. The controller 220 may, in an example embodiment, control the auto ejecting of charging connector 120. The controller 220 may determine if the electric vehicle 110 has reached a suitable state-of-charge, otherwise referred to herein as suitable charging threshold. In another example embodiment, controller 220 may determine if the EV 110 has been charging for an allotted amount of time. Further, in various embodiments, the controller 220 may adjust the time allotted or the threshold SOC granted to each electric vehicle 110. In various embodiments, the controller 220) may adjust the amount of time permitted for the electric vehicle 110 to charge based on the needs of the charging station 100. For example, if there are many electric vehicles 110 that require charging, the controller 220 may reduce the amount of time each electric vehicle may charge for or may reduce the threshold SOC each electric vehicle 110 may charge to before the auto ejecting charging connector 120 ejects. In another example embodiment, the ejection threshold may be a charging rate, where the EV may charge at a first fast charging high rate, and then when the rate of charging is reduced to a particular level, the charging connector 120 can be ejected. Again, that threshold charging rate can be a set value or one that changes under the circumstances. In various embodiments, the controller 220 may determine if the electric vehicle 110 has reached a suitable threshold, wherein the suitable threshold may be based on state-of-charge, time, charge rate, or other factors.

In various embodiments, the controller 220 may be configured to send or receive data with an external device. For example, the controller 220 may transmit a Wi-Fi or Cellular signal for communication with a smart phone or other computer. A user may receive information on their smart phone mobile app, including that the EV has a completed charge or the charging connector has been disconnected, for example.

The controller 220 may be configured to assist with various functions on the EV 110. In various embodiments, controller 220 may be implemented as a single processor and associated memory. In various embodiments, the controller 220 may be implemented as one or more processors and/or memories (e.g., a main processor and local processors for various components, a decentralized network of main processors, or the like). The controller 220 can include a general-purpose processor, a digital signal processor (DSP), an application specific integrated circuit (ASIC), a field programmable gate array (FPGA) or other programmable logic device, discrete gate or transistor logic, discrete hardware components, or any combination thereof. The controller 220 may comprise a processor configured to implement various logical operations in response to execution of instructions, for example, instructions stored on a non-transitory, tangible, computer-readable medium (e.g., memory) configured to communicate with the controller 220 (e.g., charging instructions, charging sequences, or the like).

System program instructions and/or controller instructions may be loaded onto a non-transitory, tangible computer-readable medium having instructions stored thereon that, in response to execution by a controller, cause the controller to perform various operations. The term “non-transitory” is to be understood to remove only propagating transitory signals per se from the claim scope and does not relinquish rights to all standard computer-readable media that are not only propagating transitory signals per se.

In accordance with various example embodiments, the system may be configured such that a user or other person can override the auto ejection, to continue charging in appropriate circumstances.

In various embodiments, the auto ejecting charging connector system 200 may further comprise an input device 242 and a display screen 240. The input device 242 may be configured to receive data from a user. The display screen 240 may be used to display data regarding the charging of the electric vehicle 110. For example, the display screen 240 may display the SOC of the electric vehicle 110 or the amount of time remaining for charging the electric vehicle 110.

In various embodiments, the charging connector 120 may have a lock feature configured to lock/unlock the charging connector 120 from the EV 110. In various embodiments, the controller 220 may send a signal to the lock feature to stop the flow of power to the EV 110 and unlock (disconnect) the charging connector 120 from the EV 110. In this embodiment, the charging connector 120 may be available for another user to take and connect to a ‘next’ EV. In various embodiments, the controller 220 may further be configured to physically separate the present EV from the charging connector 120. For example, the charging connector system 200 may use tension, a motor pulling on the charging connector, or the like to draw the charging connector out of engagement with a present EV. In another example embodiment, the charging connector itself may comprise pins or other structures configured to push itself out of contact with the present EV. For example, after unlocking the charging connector 120, a servo motor inside charging connector 120 may cause a pin to push against the present EV to cause the charging connector 120 to push itself out of the charge port. In any event, a physically disconnected charging connector 120 may be recoiled to hang safely away from the EV charging vehicles and people. Moreover, any suitable mechanism for auto ejection of the charging connector 120, may be used.

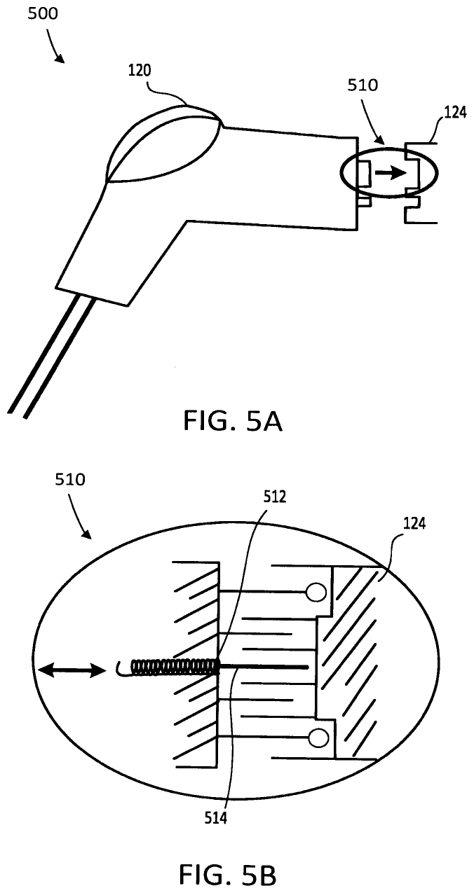

In accordance with another example embodiment, the charging system may be configured so that when a user connects the charging connector to the vehicle, doing so pre-loads a release mechanism, as described in greater detail with reference to FIGS. 5A and 5B. The vehicle control unit may have control of a release switch that releases that spring and pin mechanism, allowing it to be detached from the vehicle that just charged. This charging cord and connector will be suspended overhead to a retractable cord, that recoils once the charger is ejected. The next user can then visually see that a charge point has opened up and can now connect to it immediately.

In an example embodiment, the controller may be distributed with various control functions described herein being taken by processors in the EV, in mobile devices, in remote computers or servers, and/or the like.

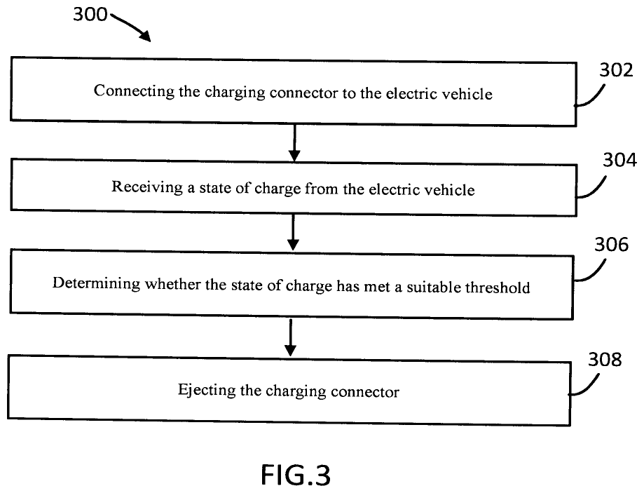

With reference now to FIG. 3, in accordance with an example embodiment, a method of auto ejecting a charging connector for an electric vehicle 300 is shown. The method 300 may comprise connecting, by a user, the charging connector to the electric vehicle. (Step 302). In various embodiments, the charging connector may charge the electric vehicle. The method 300 further comprises receiving, by a controller, a state of charge from the electric vehicle. (Step 304). Stated another way, the controller may receive a signal communicating the state of charge percentage of the battery in the connected EV. The method 300 may further 30) comprise determining, by the controller, whether the state of charge has met a suitable threshold. (Step 306). More generically, the method may comprise the step of determining, by the controller, whether or not conditions are right for auto ejecting the charging connector. In various embodiments, the ‘conditions’ may be determined based on any suitable criteria, such as, for example: an elapsed amount of time from the start of charging, the weather, ambient temperature, traffic near the charging station, number of customers, busyness of the charging station, SOC of the battery of the present EV, rate of charge, EV destination information, and or the like. The method 300 may further comprise ejecting, by the controller, the charging connector. (Step 308). The ejecting the charging connector may be in response to the state of charge, or other suitable condition, meeting the suitable threshold or other suitable criteria.

In an example embodiment, the present disclosure assumes the ability to park the next EV in proximity to the present EV, close enough to transfer the charging connector from the present EV to the next EV. Thus, the EV charging station may comprise sufficient parking space in the parking “stall” for at least two vehicles per charging connector. In the context of small EV's like scooters, people are used to maneuver their scooter around other scooters and that makes this solution more feasible than it would be for a car or truck. In another example embodiment, each primary stall is associated with a charging connector, and a spare stall is located between each primary stall, to facilitate placing the present EV and the next EV in proximity to the charging connector.

In yet another example embodiment, the auto ejection system is configured such that while charging up to the threshold, the charging connector is locked, and only the owner/driver of the EV can unlock it and stop the charging. But beyond the auto eject threshold, the charging connector is unlocked but still allowed to continue charging until another EV owner/driver wants to charge, and then they can see by the indicator that the charging connector is unlocked (available to the next user) and can stop the charging and plug in their own EV. Thus, in various example embodiments described herein, the charging station is optimized for profitability or throughput, as opposed to optimizing use around an individual EV charging. This can collectively reduce congestion at the charging station and enhance overall user experience, reduce wait times, reduce excess install capacity, advance the proliferation of charging stations, and the like.

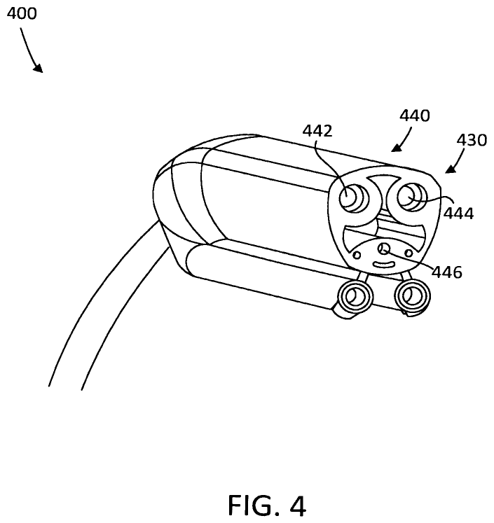

With reference now to FIG. 4, a charging connector 400 is shown, in accordance with various embodiments. The charging connector 400 may be similar in design and function to the auto ejecting charging connector 120 described in reference to FIGS. 1 and 2.

In various embodiments, the charging connector 400 comprises a connector interface 430. The connector interface 430 includes an electrical interface 440. In various embodiments, the electrical interface 440) further comprises a positive terminal 442, a negative terminal 444, and a ground terminal 446. As shown in FIG. 4, the charging connector 400 may further comprise additional ports for transmitting power and other information to an electric vehicle. Moreover, any suitable charge connector or standard of charge connector may be used.

With reference now to FIGS. 5A and 5B, a charging connector system 500 comprising a release system 510 is shown. As described with reference to FIGS. 1-4, the charging connector 120 may be removably attached to the charge port 124. In various embodiments the charging connector 120 may locked or released from the charge port 124 by a release system 510. In one example embodiment, the charging connector system 500 may comprise a release system 510 configured to cause movement of the charging connector 120 out of the charge port 124. In another example embodiment, the charging connector 120 is configured to be acted upon by an eject mechanism in the eV.

With reference to FIG. 5B an enlarged view of the release system 510 is shown, in accordance with various embodiments. In various embodiments, the release system 510 may comprise a release mechanism 512. In various embodiments, the release mechanism 512 may be housed in the charging connector 120. In various embodiments, the release mechanism 512 may comprise a pin 514 configured to push out against the charge port 124. For example, the release mechanism 512 may comprise a pin 514 attached to a spring configured to push the charging connector 120 away from the charge port 124. In various embodiments, the release mechanism 512 may be configured to smoothly push the charging connector 120 from the charge port 124. In various embodiments, once the pin 514 of the release mechanism 512 has released the charging connector 120 from the charge port 124, the pin 514 may retract back into the charging connector 120. In various embodiments, the release mechanism 512 may work in conjunction with a latching mechanism, wherein the latching mechanism is configured to connect the charging connector 120 to the charge port 124.

In the present disclosure, the following terminology will be used: The singular forms “a,” “an,” and “the” include plural referents unless the context clearly dictates otherwise. Thus, for example, reference to an item includes reference to one or more items. The term “ones” refers to one, two, or more, and generally applies to the selection of some or all of a quantity. The term “plurality” refers to two or more of an item. The term “about” means quantities, dimensions, sizes, formulations, parameters, shapes, and other characteristics need not be exact, but may be approximated and/or larger or smaller, as desired, reflecting acceptable tolerances, conversion factors, rounding off, measurement error and the like and other factors known to those of skill in the art. The term “substantially” means that the recited characteristic, parameter, or value need not be achieved exactly, but that deviations or variations, including, for example, tolerances, measurement error, measurement accuracy limitations and other factors known to those of skill in the art, may occur in amounts that do not preclude the effect the characteristic was intended to provide. Numerical data may be expressed or presented herein in a range format. It is to be understood that such a range format is used merely for convenience and brevity and thus should be interpreted flexibly to include not only the numerical values explicitly recited as the limits of the range, but also interpreted to include all of the individual numerical values or sub-ranges encompassed within that range as if each numerical value and sub-range is explicitly recited. As an illustration, a numerical range of “about 1 to 5” should be interpreted to include not only the explicitly recited values of about 1 to about 5, but also include individual values and sub-ranges within the indicated range. Thus, included in the numerical range are individual values such as 2, 3 and 4 and sub-ranges such as 1-3, 2-4 and 3-5, etc. The same principle applies to ranges reciting only one numerical value (e.g., “greater than about 1”) and should apply regardless of the breadth of the range or the characteristics being described. A plurality of items may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. Furthermore, where the terms “and” and “or” are used in conjunction with a list of items, they are to be interpreted broadly, in that any one or more of the listed items may be used alone or in combination with other listed items. The term “alternatively” refers to selection of one of two or more alternatives and is not intended to limit the selection to only those listed alternatives or to only one of the listed alternatives at a time, unless the context clearly indicates otherwise.

It should be appreciated that the particular implementations shown and described herein are illustrative of the example embodiments and their best mode and are not intended to otherwise limit the scope of the present disclosure in any way. Furthermore, the connecting lines shown in the various figures contained herein are intended to represent exemplary functional relationships and/or physical couplings between the various elements. It should be noted that many alternative or additional functional relationships or physical connections may be present in a practical device.

As one skilled in the art will appreciate, the mechanism of the present disclosure may be suitably configured in any of several ways. It should be understood that the mechanism described herein with reference to the figures is but one exemplary embodiment of the disclosure and is not intended to limit the scope of the disclosure as described above.

It should be understood, however, that the detailed description and specific examples, while indicating exemplary embodiments of the present disclosure, are given for purposes of illustration only and not of limitation. Many changes and modifications within the scope of the instant disclosure may be made without departing from the spirit thereof, and the disclosure includes all such modifications. The corresponding structures, materials, acts, and equivalents of all elements in the claims below are intended to include any structure, material, or acts for performing the functions in combination with other claimed elements as specifically claimed. The scope of the disclosure should be determined by the appended claims and their legal equivalents, rather than by the examples given above. For example, the operations recited in any method claims may be executed in any order and are not limited to the order presented in the claims. Moreover, no element is essential to the practice of the disclosure unless specifically described herein as “critical” or “essential.”

What is claimed:

1. A charging connector for an electric vehicle comprising:
a power supply electrically connected to the charging connector by a cable:
wherein the charging connector is configured to charge the electric vehicle; and
wherein the charging connector is further configured to eject from the electric vehicle when the electric vehicle reaches a suitable threshold.

2. The charging connector of claim 1, wherein the cable is a retractable cable configured to retract when the charging connector is ejected.

3. The charging connector of claim 1, wherein the suitable threshold is where a state of charge of the electric vehicle is greater than 75% charged.

4. The charging connector of claim 1, wherein the suitable threshold is where the charging connector has charged the electric vehicle for more than a period of time.

5. The charging connector of claim 1, wherein the electric vehicle is one of: an electric scooter (eScooter), an electric bike (eBike), an electric moped (eMoped), an electric motorcycle (eMotorcycle), an electric trike (eTrike), an electric all-terrain-vehicle (eATV), a side-by-side, a utility terrain vehicle, a multipurpose off-highway utility vehicle, a golf cart, a boat, a one-wheel, or a hoverboard.

6. The charging connector of claim 1, wherein the electric vehicle is one of a one-wheel, two-wheel or three-wheel electric vehicle.

7. The charging connector of claim 1, further comprising an indicator light, wherein the indicator light is configured to emit light when the electric vehicle reaches the suitable threshold.

8. The charging connector of claim 1, further comprising a controller configured to determine when it would be advantageous to stop charging the electric vehicle in favor of starting charging a next electric vehicle, wherein the controller is configured to stop charging the electric vehicle upon such determination, wherein the controller is configured to provide a signal to the charging connector to unlock the charging connector from the electric vehicle.

9. An auto ejecting charging connector system for an electric vehicle comprising:
a power supply electrically connected to a charging connector configured to provide a charge to the electric vehicle; and
a controller electrically connected to the charging connector, the charging connector connected to the electric vehicle;
wherein the controller is configured to eject the charging connector from the electric vehicle when the electric vehicle reaches a suitable threshold.

10. The auto ejecting charging connector system of claim 9, wherein the suitable threshold is where a state of charge of the electric vehicle is greater than 75% charged.

11. The auto ejecting charging connector system of claim 9, wherein the suitable threshold is where the charging connector has charged the electric vehicle for more than a period of time.

12. The auto ejecting charging connector system of claim 9, wherein the electric vehicle is one of: an electric scooter (eScooter), an electric bike (eBike), an electric moped (eMoped), an electric motorcycle (eMotorcycle), an electric trike (eTrike), an electric all-terrain-vehicle (eATV), a side-by-side, a utility terrain vehicle, a multipurpose off-highway utility vehicle, a golf cart, a boat, a one-wheel, or a hoverboard.

13. The auto ejecting charging connector system of claim 9, wherein the electric vehicle is one of a one-wheel, two-wheel or three-wheel electric vehicle.

14. The auto ejecting charging connector system of claim 9, further comprising a display screen, the display screen for displaying a state of charge of the electric vehicle.

15. The auto ejecting charging connector system of claim 9, wherein the controller is configured to determine when it would be advantageous to stop charging the electric vehicle in favor of starting charging a next electric vehicle, wherein the controller is configured to stop charging the electric vehicle upon such determination, wherein the controller is configured to provide a signal to the charging connector to unlock the charging connector from the electric vehicle.

16. A method of auto ejecting a charging connector for an electric vehicle, the method comprising:
connecting, by a user, the charging connector to the electric vehicle, wherein the charging connector is charging the electric vehicle;
receiving, by a controller, a state of charge from the electric vehicle;
determining, by the controller, whether the state of charge has met a suitable threshold; and
ejecting, by the controller, the charging connector, in response to the state of charge meeting the suitable threshold.

17. The method of claim 16, further comprising:
retracting, by a cable, the charging connector in response to the ejecting the charging connector, wherein the cable is connected to the charging connector and a charging station.

18. The method of claim 16, further comprising:
emitting, by an indicator light, a light indicating that the charging connector is ejected and available for use.

19. The method of claim 16, wherein the electric vehicle is one of: an electric scooter (eScooter), an electric bike (eBike), an electric moped (eMoped), an electric motorcycle (eMotorcycle), an electric trike (eTrike), an electric all-terrain-vehicle (eATV), a side-by-side, a utility terrain vehicle, a multipurpose off-highway utility vehicle, a golf cart, a boat, a one-wheel, or a hoverboard.

20. The method of claim 16, wherein the suitable threshold is where the state of charge of the electric vehicle is greater than 75% charged.
